(19) United States
(12) Patent Application Publication
(10) Pub. No.: US 2026/0067161 A1
(43) Pub. Date: Mar. 5, 2026

(54) METHOD AND SYSTEM FOR ENERGY EFFICIENT SERVICE PLACEMENT IN AN EDGE CLOUD

(71) Applicant: TELEFONAKTIEBOLAGET LM ERICSSON (PUBL), Stockholm (SE)

(72) Inventors: Xuejun CAI, TÄBY (SE); Kun WANG, SOLNA (SE); Arif AHMED, SILCHAR (IN); Selome Kostentinos TESFATSION, UPPLANDS VÄSBY (SE)

(21) Appl. No.: 19/106,918

(22) PCT Filed: Aug. 30, 2022
(86) PCT No.: PCT/SE2022/050778

§ 371 Date: Feb. 26, 2025

(51) Int. Cl. H04L 41/0833; H04W 24/08

(52) U.S. Cl. CPC H04L 41/0833; H04W 24/08

(57) ABSTRACT

A method for an energy-efficient service placement in a mobile edge cloud comprising at least one edge site is disclosed. The method comprises receiving a service placement request from a service provider. The method comprises identifying a set of candidate edge site groups and calculating a first energy efficiency value for each identified candidate edge site group. Further, the method comprises calculating a second energy efficiency value for components of the cellular network that are involved in the communication between the user device and the edge site. The method comprises determining for each candidate edge site group, an energy efficiency metric for deploying said service placement request in a traffic path of the cellular network based on the first and second energy efficiency values. The method further comprises determining a service placement policy for the service placement based on the calculated energy efficiency metric and the obtained performance parameters.

The present application relates to a field of edge cloud and more specifically to method and system for performing energy efficient service placement in the edge cloud.

### BACKGROUND

In recent years, Wide Area Network (WAN) edge infrastructure has been used for providing data and services delivered from data centers and a cloud. Such WAN edge infrastructure provides easy access to cloud hosted applications/services which requires high computing capabilities by having connectivity with a WAN edge, also known as edge cloud. Certain types of applications, for example, Augmented Reality/Virtual Reality applications, IoT applications, self-driving cars, gaming are preferably deployed in the edge cloud in order to reduce service latency associated with offloading massive volumes of data from the cloud. Such applications which are deployed using edge cloud are hereafter referred to as edge services. Thus, using the edge cloud, edge services can be provided to user devices (for example, a mobile phone) connected to the WAN through a mobile network. In aforesaid scenarios, energy saving and energy efficiency in the mobile network are critical to mobile network operators from both cost and sustainability perspective. Thus, it is essential to provide a sustainable edge computing environment which can improve the energy efficiency and reduce the energy consumption when the edge services are deployed.

One typical approach ([1], [2]) to improve energy efficiency in 3rd Generation Partnership Project (3GPP) includes defining Key Performance Indicators (KPI) for energy efficiency for a whole network, sub-network, network elements and the like. The aforesaid KPI's are primarily used for determining energy efficiency of the cellular network. However, said KPIs cannot be used directly by the edge cloud to improve overall energy efficiency of the edge services (e.g., AR/VR, gaming) deployed.

In another approach of energy saving in 3GPP ([3], [4]), parameters such as dynamic energy saving state activation, efficient radio resource management, and network data analysis based energy saving are considered. Herein, only components of the cellular network are considered for energy efficiency operation using aforesaid parameters. But said energy efficiency operation has no relation to operation of edge services in the edge cloud.

An example implementation of a WAN edge cloud is illustrated in FIG. 1, with a plurality of distributed and micro edge sites 102, 103, and 104. The edge sites are connected to the cellular network 110 via the data plane gateways like UPFs in 5G. The edge service 101 is first deployed in any of edge sites and then accessed by user devices present in a radio network 115. There are two possible traffic paths 106, 108 through the UPF from the edge sites 102, 105 to the radio network 115. In order to provide the edge service to the user devices in the wide area network and meet their performance requirements (for example, low latency, high data throughput and the like), the edge services should be distributed among multiple edge sites 102, 103, and 104. Due to the limited capacity of the edge sites (102, 103, and 104), it is almost impossible to deploy all edge services in all edge sites present in the WAN edge cloud. Therefore, it is essential to determine one or more edge sites from the WAN edge cloud to deploy the edge service (or instances of the service). The aforesaid scenario is referred as service placement problem, which can have significant impact on multiple aspects of the edge services, for example, the performance, cost, and energy consumption as well.

There exist some methods to optimize the energy consumption of the edge services when performing the service placement. An existing method [5] teaches an energy-efficient service scheduling algorithm in federated edge cloud that minimizes energy consumption on a service path while ensuring QoS at the same time. In said method, the energy consumption is modeled as a function of the resource usage of all Virtual Machines (VMs) assigned to the service and the traffic traversed between the network ports of the VMs. However, the method doesn't consider the energy consumption incurred into the cellular network by the traffic traversing through the mobile network. Therefore, the overall energy efficiency associated with the service placement is not optimized

Another existing method [6] for optimizing energy consumption of edge services teaches usage of AI-based services on a minimal number of edge sites while meeting performance requirements. The method includes modeling the service placement as a multi-period optimization problem to capture the dependencies of placement decision across multiple time periods and used heuristic method to perform the service placement. The method determines network information of the edge sites in order to meet the latency requirements associated with the edge services. However, said method considered the energy efficiency only in the edge sites or nodes and doesn't consider the overall energy efficiency including the impact from the mobile network.

Accordingly, there is a need to overcome the above-mentioned problems and to provide a sustainable edge computing environment which can improve the energy efficiency and reduce the energy consumption when the edge services are deployed. Further, there exists a need to consider energy consumption in cellular network along with the energy consumption of the edge cloud during service placement.

### SUMMARY

The drawbacks associated with service placement in edge cloud maybe overcome by providing a method for energy-efficient service placement as mentioned in features of the independent claims. Further aspects are described in the dependent claims.

It is an object of embodiments herein to address the problem of service placement in a cloud edge to improve energy efficiency and reduce energy consumption when edge services are deployed. It is also an object of the embodiments herein to determine an energy consumption in cellular network along with the energy consumption of the edge cloud during service placement.

According to a first aspect of the present disclosure there is provided a method performed by a computing system for an energy-efficient service placement in a mobile edge cloud comprising at least one edge site. The method comprises receiving a service placement request from a service provider. The method further comprises obtaining performance requirements associated with the service placement request from a service provider. The method comprises identifying a set of candidate edge site groups from a plurality of edge sites present in the edge cloud. The method comprises calculating a first energy efficiency value for each identified candidate edge site group. Further, the method comprises calculating a second energy efficiency value for components of the cellular network that are involved in the communication between the user device and the edge site. The method comprises determining for each candidate edge site group, an energy efficiency metric for deploying said service placement request in a traffic path of the cellular network based on the first and second energy efficiency values. The method further comprises determining a service placement policy for the service placement based on the calculated energy efficiency metric and the obtained performance parameters.

According to a second aspect of the present disclosure there is provided a computing system for performing an energy-efficient service placement in a mobile edge cloud comprising at least one edge site. The computing system includes a memory that stores instructions and a processor coupled to the memory coupled to the memory to execute the instructions. The computing system is configured to receive a service placement request from a service provider. The computing system is configured to obtain performance requirements associated with the service placement request from a service provider. The computing system is configured to identify a set of candidate edge site groups from a plurality of edge sites present in the edge cloud, wherein the candidate edge sites are adjacent to the user device and satisfy latency and coverage requirements associated with the service placement request. The computing system is further configured to calculate a first energy efficiency value for each identified candidate edge site group. The computing system is further configured to calculate a second energy efficiency value for components of the cellular network that are involved in communication between the user device and the edge site. The computing system is configured to determine for each candidate edge site group, an energy efficiency metric for deploying said service placement request in a traffic path of the cellular network based on the first and second energy efficiency values. Finally, the computing system is configured to determine a service placement policy for the service placement based on the calculated energy efficiency metric and the obtained performance requirements.

Certain embodiments may provide an advantage of optimizing overall energy efficiency for the edge services deployed in the mobile edge environment. Further, the service provider, particularly the edge cloud provider can use the information from the energy consumption corresponding to the edge service and then use the information for taking actions to improve the edge service.

### BRIEF DESCRIPTION OF THE DRAWINGS

The accompanying drawings, which are included to provide a further understanding of the disclosure and are incorporated in a constitute a part of this application, in which:

FIG. 1 is a schematic diagram illustrating an WAN edge cloud environment, according to existing methods:

FIG. 2a is a schematic diagram illustrating service placement in a mobile edge cloud, according to some embodiments herein:

FIG. 2b is a schematic diagram illustrating an exemplary energy calculation according to some embodiments herein:

FIGS. 3a and 3b is a schematic flowchart illustrating a method according to some embodiments herein:

FIG. 4 is a schematic block diagram illustrating a non-limiting example arrangement of a system, according to some embodiments herein; and

FIG. 5 is a schematic block diagram of the system according to some embodiments herein.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

Some of the terminologies used in this disclosure are explained below:

Edge site: Edge sites are edge nodes with one or more edge servers present in the edge cloud and having computing capabilities to store, process and deploy edge services. The edge sites present within the edge cloud could be geographically distributed.

Replicates of service: Replicates is one or more instances of the service deployed in a device or user device.

Site Serving Area (SSA): Site serving area are radio network areas adjacent to an edge site such that edge services accessed by user devices satisfies minimum requirement of service latency. SSA is measured for an edge site.

Candidate edge site group (CSG): Candidate edge sites are group of edge sites geographically adjacent to a user device for deploying an edge service and satisfy latency and coverage requirements and other requirements associated with the service placement request. The CSG is determined according to coverage requirements and the Site Serving area of each edge site and the serving area can cover whole service coverage area requested by the service provider.

Network Exposure Function (NEF): NEF facilitates secure, robust, developer-friendly access to exposed network services and capabilities.

Service provider: Service provider is a company which allows its subscribers or users access to the internet.

Service path: Service path in the present disclosure refers to a path among the multiple components (or microservices) belonging to the service. It typically covers the path in the cloud domain.

Traffic path: Traffic path in the present disclosure refers to the path from a user equipment or user device to the service in the cloud. Traffic path includes path along the cellular network to the edge cloud.

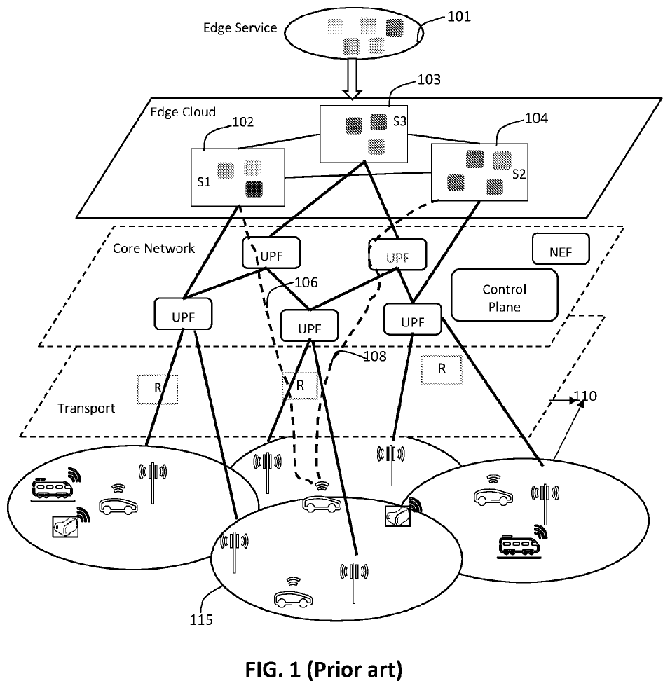

The embodiments described herein address the problem of service placement in a cloud edge to improve energy efficiency and reduce energy consumption when edge services are deployed. As illustrated in FIG. 1, during service placement, edge services are deployed via edge sites to the end users in a cellular network, then a traffic is generated which traverses through network layers including radio, transport and core networks when the users or user devices access said services. In order to provide a sustainable edge computing environment, it is essential to consider an energy consumption in components of the cellular network along with an energy consumption of an edge cloud during aforesaid service placement. Thus, it is desirable to have a method and system to determine the energy consumption in cellular network along with the energy consumption of the edge cloud during service placement. It is also desirable to consider the performance requirements associated with the edge service during such service placements. Edge services will be hereafter referred to as service.

The embodiments herein describe a method and computing system for an energy-efficient service placement in a mobile edge cloud. The method comprises determining a first energy efficiency value for edge sites present in the edge cloud and also determining a second energy efficiency value for components of the cellular network. The method further comprises determining a service placement policy for the service placement based on an energy efficiency metric (calculated from the first and second energy efficiency values) and performance requirements associated with the service placement. The service placement policy selects an edge site group with highest energy efficiency metric from a set of candidate edge site groups for service placement.

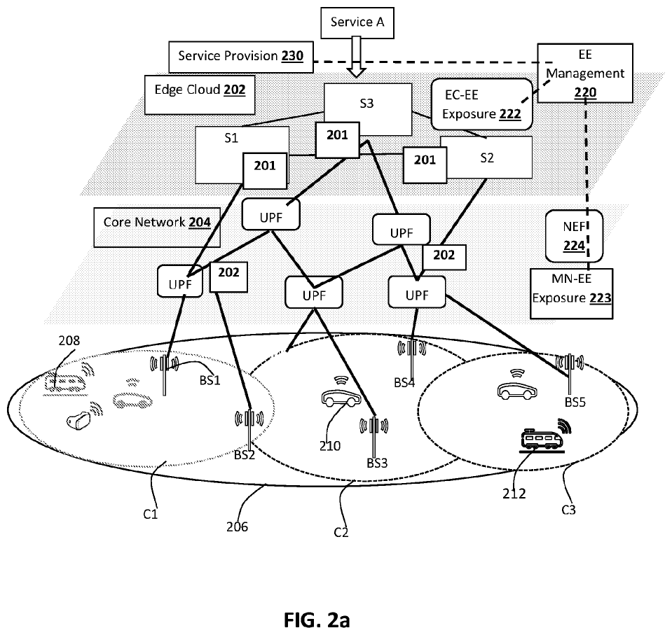

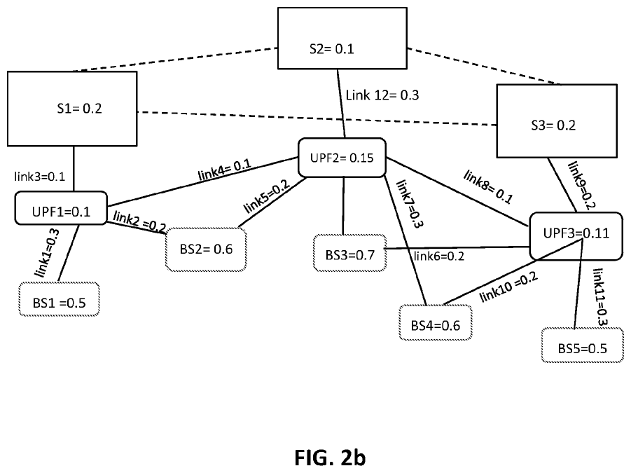

FIG. 2a is a schematic diagram illustrating service placement in a mobile edge cloud, wherein embodiments herein may be implemented. As shown in FIG. 2a, the edge cloud 202 is placed close to the cellular network. The cellular network is shown in a cluster 206 with cell sites C1, C2, C3, where each cell site is served by at least one fixed-location transceiver known as base station (for example, base station B1). The edge cloud 202 is communicably coupled to user devices (208, 210, 212 and the like) via a core network 204 and base stations (BS1, BS2, . . . . BS5) present in the cluster 206. The edge cloud 202 includes a plurality of sites S1, S2, S3, where each site has one or more edge servers. The edge sites for deploying edge services or applications are determined by a service placement function 230. Herein, the edge services to be deployed has a latency requirement of less than 10 milliseconds. In an embodiment, the service placement request is generated by a cloud service provider. In another embodiment, the service placement request maybe generated by user devices.

FIG. 2a further illustrates the components involved in estimating the energy efficiency of the edge cloud and the cellular network, when an edge service ‘A’ needs to be deployed in response to a service placement request. The mobile edge cloud environment includes a plurality of energy monitors 201 and 202 to measure energy efficiency values from the edge cloud and the cellular network respectively. According to embodiments herein, the mobile edge cloud environment also includes an Energy Efficiency Management (EEM) function 220 and a service provision function 230 that is configured to receive energy values and identify a set of candidate server groups and further determine an energy efficiency metric for the identified candidate server groups, where the energy efficiency metric helps to define a service placement policy and select a candidate server group for deployment. The detailed working of various functions responsible for energy measurement and service placement is provided below.

According to embodiments herein, the service placement function 230 present in the edge cloud 220 receives the service placement request for deploying edge service ‘A’ in the user devices (208, 210, 212 and the like). The service placement function 230 instructs the EEM function 220 to receive energy efficiency values from edge cloud and cellular network. The service provision (SP) function 230 maybe implemented in the edge cloud or in a computing system or a server apparatus. The service provision function 230 is configured to determine an edge site or edge site group for service placement such that edge services satisfy performance requirements while reducing energy consumption. The performance requirements comprise at least one of latency, throughput, and coverage requirement associated with the application placement request. According to an embodiment herein, the SP function 230 is configured to calculate a potential serving network area of the service's replicate(s) in each edge site S1, S2 or S3. When the end user is accessing the service replicate running in the edge site from any place within the serving area, the network latency will meet the minimum requirement of the service. Such serving area is referred as the Site Serving Area (SSA) of the service. It is to be noted that for the services with different latency requirements, the SSA could be different. In the example of FIG. 2a, the SSA includes edge sites S1, S2 and S3. Thereafter, the service provision function 230 is configured to identify a set of candidate edge site groups from a plurality of edge sites present in the edge cloud, wherein the candidate edge sites are adjacent to the user device and satisfy latency and coverage requirements associated with the service placement request. With respect to FIG. 2a, the candidate edge site groups CSG1 selected could be a combination of edge site S1 and S3 with SSA of BS1, BS2, BS3, BS4, and BS5 respectively. Another candidate edge site group CSG2 could be a combination of edge site S3 and site S2 whose SSA includes BS4, BS5, BS1, BS2, BS3, and BS4.

After identifying candidate edge site groups, energy efficiency values are measured and calculated. The EEM function 220 is configured to receive energy efficiency information about the components of the cellular network through energy monitors 202. The EEM function is also configured to receive energy efficiency values from the energy monitors 201 located in the edge cloud 220. The EEM function 220 is also communicably coupled to an Edge Cloud Energy Exposure (EC-EE) function 222 present in the edge cloud 202. The EC-EE function 222 receives energy efficiency values from a plurality of energy efficiency monitors 201 located in the edge cloud. The EC-EE monitors 201, which are in each edge site is configured to measure or estimate an energy efficiency metric of the edge services running therein. In a scenario, when there may be no running instance of a given edge service, the EC-EE monitors can estimate or calculate the EE metric according to history metric, service type, and pre-defined models. The energy efficiency values from energy monitors 201 are received by the EC-EE function 222 to determine a first energy efficiency value for each edge site S1, S2 or S3. The Edge Cloud Energy Exposure (EC-EE) function 222 is configured to collect the EE metrics measured or estimated by the EC-EE Monitors, pre-process the metrics if needed and communicate aforesaid metrics to the Energy Efficiency Management function (EEM) 220.

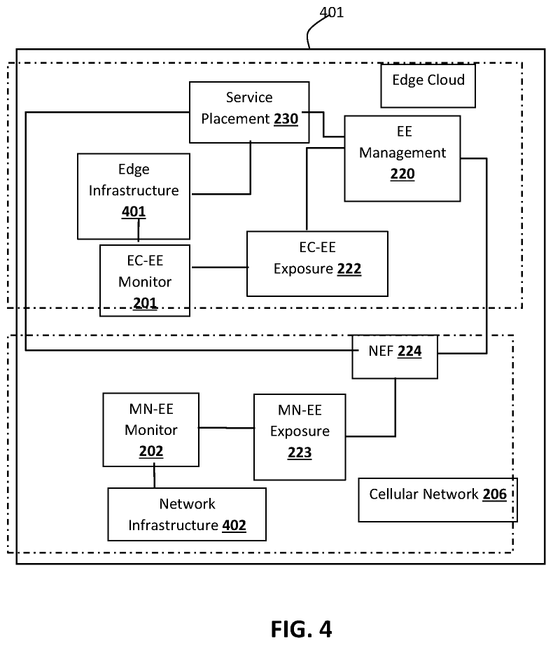

Correspondingly, the energy efficiency values of the cellular network maybe measured by a mobile network energy efficiency monitor (MN-EE) 202. The energy efficiency values for components such as sub-networks, physical network function, virtual network function and other related entities are measured according to the standard specifications (Management and orchestration: 5G end to end Key Performance Indicators (KPI), [TS28.554, 3GPP]) defined in 3GPP by the MN-EE Monitor 202. In an embodiment herein, the MN-EE Monitor 202 is a logical function which could be a separate component or part of other component and there could be multiple MN-EE Monitors distributed in the core network 204 and base station (in cluster 206) adjacent to different components different parts of the network. The MN-EE monitors 202 is coupled to a MN-EE exposure function 223 (shown as MN-EE Exposure in FIG. 2a and FIG. 4), which may be configured to calculate a second energy efficiency value for components of the cellular network that are involved in the communication between the user device and the edge site, where the second energy efficiency value corresponds to energy efficiency of cellular components in real-time. In an exemplary embodiment, the MN-EE exposure function 223 is responsible for collecting the EE metrics measured by the MN-EE monitors, pre-processing the metrics if needed, and exposing such information to functions in the edge cloud side through a Network Exposure Function (NEF) 224. The calculated second energy efficiency value is transmitted to the EEM function 220 through an interface of Mobile Network Energy Efficiency Exposure 223 function and the Network Exposure Function (NEF) 224. The Network exposure function 224 (shown as NEF in FIG. 2a) is a standard function present in 4G and 5G that enables to share network data and resources between different applications, IoT devices, edge loads and the like for can be accessible for implementing new use-cases or applications. In another embodiment, the MN-EE exposure function 223 could be part of NEF 224 directly. In an example embodiment herein, only energy efficiency information required by the edge cloud are exposed.

The Energy Efficiency Management function (EEM) 220 receives the energy efficiency values (first and second energy efficiency values) from the edge cloud and the cellular network and communicates the energy efficiency values with the service provision function 230. The SP function 230 is further configured to determine a service placement policy for the service placement based on the energy efficiency values received and the obtained performance parameters. For example, the SP function 230 determines an edge site group (CSG1 in this example) from the set of candidate edge site groups (CSG1 and CG2 in this example) to deploy service A, so that energy efficiency is improved while satisfying performance requirements. The calculation of energy efficiency for edge service deployment is elaborated below:

Energy Efficiency (EE) metric for edge service

Given an edge service S, as shown in Error! Reference source not found., a mobile edge cloud c consists of multiple edge sites (S1, S2 . . . , Sn), and c denotes the set of the edge sites in which there is one or more running replicate of S. Let EE_{Sc} denotes the energy efficiency metric of S_{c}, i.e., when service S is deployed in the set of the edge sites c, then

$${EE}_{Sc} = \frac{PM}{{EC}_{Sc}} \qquad ( 1 )$$

wherein, PM denotes the performance metrics of S_{c}, and EC_{Sc} is the overall energy consumption related to all replicates of the service S in the edge set c. In an embodiment herein, the performance metric used is the total data volume (DV) transferred between the user devices and the service replicates in the edge cloud. Data Volume is also the main performance metric used in the energy efficiency related KPI in 5G network (Energy efficiency calculation of 5G network is described in technical specification [7]) and Equation I can be rewritten as:

$${EE}_{Sc} = \frac{DV}{{EC}_{Sc}} = \frac{DV}{{\sum }_{i ∈ c} {EC}_{Si}} \qquad ( 2 )$$

EC_{Si} is the energy consumed by all replicates of service S in edge site i, where i=1, 2, or 3. In some scenarios, it could be difficult to measure the energy consumption of the data volume for some components or sub-network in the mobile network (particularly in the radio network which doesn't have the service information of the traffic). But the energy consumption of all data volume going through the component or subnetwork in a specified period could be measured, and then the energy efficiency could be obtained by dividing the total volume by all energy consumption. Thus, it is presumed that EC_{Si} could instead be estimated by DV_{Si}*EE_{Si}. Then:

$${EE}_{Sc} = \frac{DV}{{\sum }_{i ∈ c} {DV}_{Si} * {EE}_{Si}} \qquad ( 3 )$$

DV_{Si} denotes the data volume of the traffic to/from all the replicates in site i. The data volume DV_{Si} depends on multiple dynamic factors, for example, request routing performed in the network, the dynamic load variation, and the high user mobility. To accurately determine DV_{Si}, it is considered DV_{Si} as the portion of the total data volume DV according to some models (for example, dividing equally or with weight among all edges in the set c) or history metric.

EE_{Si} denotes the estimated overall energy efficiency of the replicates of service S in site i which includes the related Energy Consumption (EC) in the mobile network.

Let ai denotes the Site Serving Area (SSA) of service S running in edge site i, then EE_{Si} contains two parts:

$${EE}_{Si} = {EE}_{Si\_ai} + {EE}_{Si\_es} \qquad ( 4 )$$

EE_{Si_ai} denotes the energy efficiency related to the data transferred in the SSA ai; and EE_{Si_es} denotes the energy efficiency related to the data transferred from/to the replicates of S in edge site i.

EE_{Si_ai} could be calculated by the MN-EE Exposure function 223 according to the metrics measured by related MN-EE monitors 202, and exposed to the EEM function 220 which will send EE_{Si_ai} values to the SP function 230. Below is an example function to calculate EE_{Si_ai}.

$${EE}_{{Si}_{ai}} = Avg {\sum }_{m} {EE}_{{tp}_{m}} , m ⊂ BS in area ai , \qquad ( 5 )$$

EEₜₚ_{ₘ} denotes the energy efficiency metric along the traffic path from the edge site i (only the edge domain) towards the BSs in its SSA. The details about calculation of EEₜₚ_{ₘ} maybe decided by the mobile network operator.

EE_{Si_es} is the energy efficiency metric of the replicates of S in edge site i. Below is an example formula to calculate EE_{Si_es} (which maybe used by the edge cloud provider):

$${EE}_{Si\_es} = \frac{{DV}_{st}}{{\sum }_{j} {EC}_{ij}} \qquad ( 6 )$$

ECᵢⱼ is the energy consumed by replicate j of service S in site i. ECᵢⱼ can be measured directly with hardware or software meter if there is already running replicate. Otherwise, ECᵢⱼ could be estimated or calculated with pre-defined model according to the characteristics and/or the resource (e.g., CPU) requirements of the service. The pre-defined model could be a machine learning model trained with historical data. The pre-defined model could also be a regression learning model. The usage of equations (1) to (6) in energy calculation is further elaborated in FIG. 2b.

FIG. 2b is a schematic diagram illustrating an exemplary energy calculation according to some embodiments herein. The diagram shows edge sites S1, S2, and S3 connected to base stations BS1, BS2, BS3, BS4, and BS5 through user plane functions (UPFs) of the cellular network. The link between the UPFs, base stations and edge sites S1, S2 and S3 are depicted as link 1, link 2, link 3, . . . and link 11 in FIG. 2b. The network topology and the network latency of those aforesaid could be provided by cellular network operators through the Network Exposure Function. Based on the network topology and the latency of each link, the 230 can calculate the SSA of each edge site for the given service.

The energy efficiencies of different components are shown in FIG. 2b and the unit of the EE is kWh/GB. In an example, it assumed that there are two CSGs for service A: CSG1 (site 1 and 3), and CSG 2 (site 2 and 3). Herein, firstly we could calculate the EE_{Si}_{ₐᵢ} (i.e., the energy efficiency related to the data transferred in the Site Serving Area of each edge site) with equation (5) (EE_{Si}_{ₐᵢ}=Avg Σₘ EEₜₚ_{ₘ}, m⊂BS in area ai).

For example, for edge site S1, EE_{S1}_{ₐ₁}=avg (EEₜₚ_{_{bs1}}+EEₜₚ_{_{bs2}}+EEₜₚ_{_{bs3}}) and EEₜₚ_{_{bs}} is calculated by adding the energy efficiency of all components along the path to the base station, i.e., EEₜₚ_{_{bs1}}=(0.1+0.1+0.3+0.5)=1.0, EEₜₚ_{_{bs2}}=(0.1+0.1+0.2+0.6)=1.0, EEₜₚ_{_{bs3}}=(0.1+0.1+0.1+0.15+0.3+0.7)=1.45.

Hence EE_{S1}_{ₐ₁}=1.15. EE_{S1_es}=0.2 is already shown in the figure. Then according to equation (4) (EE_{Si}=EE_{Si_ai}+EE_{Si_es}), EE_{S1}=EE_{S1}_{ₐ₁}+EE_{S1_es}=1.35.

Similarly, EE_{S2} and EE_{S3} can be calculated and the results are EE_{S2}=1.475, EE_{S3}=1.31.

Further, in above example, it is calculated that there are two CSGs for service A: CSG1 (S1 & S2), CSG2 (S2 & S3). Then EE_{Sc}, which is the Energy Efficiency of Service A when deployed in the given CSG can be calculated according to equation (3)

$$( {EE}_{Sc} = \frac{DV}{{\sum }_{i ∈ c} {DV}_{Si} * {EE}_{Si}} ) .$$

Here, it is assumed that the service traffic are evenly distributed in each site of the CSG, then EE_{Scsg1}≈1.41 and EE_{Scsg2}≈1.39. Because EE_{Scsg1}>EE_{Scsg2}, CSG1 would be selected by the service provision function 230, and thus the service A will be deployed into edge site 1 and site 2 which form part of CSG1.

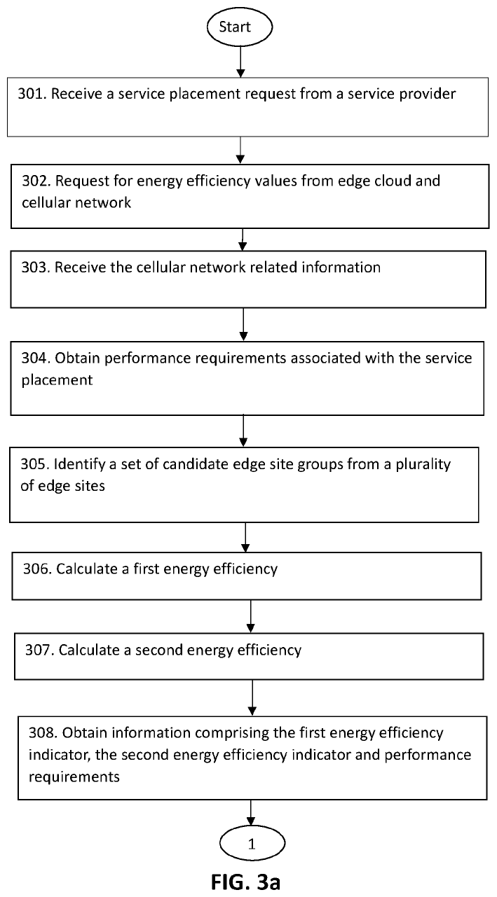

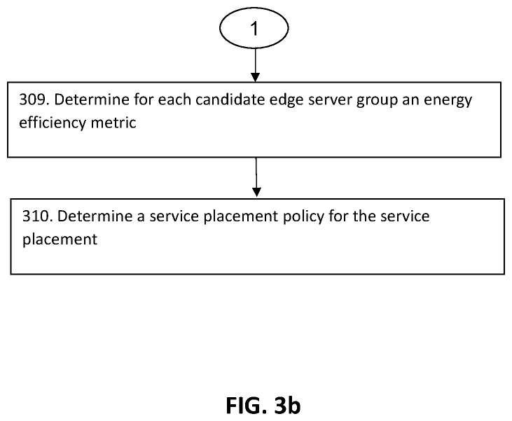

The method steps performed by EE Management function 220 and service provision function 230 for energy efficient service placement is depicted in FIG. 3a and FIG. 3b. The EE Management function 220 and service provision function 230 may be part of a computing system 401. FIGS. 3a and 3b are flowcharts illustrating a method for performing energy-efficient service placement in a mobile edge cloud.

According to embodiments herein, the method comprises step 301 of receiving a service placement request from a service provider. In response to receiving the service placement request, the service provision function 230 is requested to calculate a placement policy for the edge service.

The method further comprises step 302 of requesting energy efficiency values from the edge cloud and the cellular network. The energy efficiency values are continuously measured by the energy monitors 202 and 201 located in the cellular network and the edge cloud respectively. After measuring, the energy efficiency values are communicated to the EE Management function 220 and the service provision function 230.

The method further comprises step 303 of receiving the cellular network related information including latency, network topology and edge infrastructure related information including a list of edge sites. The cellular network related information and edge infrastructure related information is received by the service provision function.

The method further comprises step 304 of receiving performance requirements associated with the service placement request from the service provider. The performance requirements include at least one of latency, throughput, and coverage requirement associated with the application placement request. The performance requirements are considered to enable edge service deployment in edge sites with low latency in good coverage areas.

The method further comprises step 305 of identifying a set of candidate edge site groups from a plurality of edge sites present in the edge cloud. The candidate edge sites are adjacent to the user device and satisfy latency and coverage requirements associated with the service placement request. As shown in FIG. 2a, the edge sites include S1, S2, and S3, and the set of candidate edge groups include a first group with edge sites S1, S3 with BS1, BS2, BS3, BS4, and BS5 and second group with edge sites S3, S2 along with BS4, BS5, BS1, BS2, BS3, BS4.

The method further comprises step 306 of calculating a first energy efficiency value for each identified candidate edge site group. The first energy efficiency value for each of a plurality of candidate edge-site group is calculated by the equation:

$${EE}_{Sc} = \frac{PM}{{EC}_{Sc}}$$

wherein, EE_{Sc} denotes the energy efficiency metric of S_{c}, when service S is deployed in the set of the edge site group c, and PM denotes the performance metrics of S_{c}, and EC_{Sc} is sum of energy consumption related to all replicates of the service S in the edge set c.

The method further comprises step 307 of calculating a second energy efficiency for the components of the cellular network that are involved in the communication between the user device and the edge site. The components of the cellular network comprises at least one of a base station, a user device, and a user plane function. The second energy efficiency indicator for components of the cellular network is calculated by the equation:

$${EE}_{{Si}_{ai}} = Avg {\sum }_{m} {EE}_{{tp}_{m}} , m ⊂ BS in area {a}_{i} ,$$

wherein, EE_{Si}_{ₐᵢ} refers to an efficiency related to a data transferred in an area aᵢ serviceable by the set of candidate edge site groups, and EEₜₚ_{ₘ} denotes an energy efficiency metric along a traffic path from an edge site (i) towards base stations of the cellular network in the serviceable area aᵢ.

The method comprises step 308 of obtaining information comprising the first energy efficiency indicator, the second energy efficiency indicator and performance requirements associated with the application placement request. The aforesaid information is received by the service provision function and used in determining the service placement policy.

The method further comprises step 309 of determining for each candidate edge site group, an energy efficiency metric for deploying said service placement request in a traffic path of the cellular network based on the first and second energy efficiency values.

The method further comprises step 310 of determining a service placement policy for the service placement based on the calculated energy efficiency metric and the obtained performance parameters. The step of determining the service placement policy includes selecting an edge site group for the service placement, from the set of candidate edge site groups, with a highest energy efficiency metric indicator among the determined energy efficiency metrics. With reference to the example in FIG. 2b, the first candidate service group with highest energy efficiency metric maybe selected by the service provision function.

According to an embodiment herein, the energy efficiency values from the edge cloud and the cellular network may be continuously shared with the service provision function through exposure functions (MN-EE exposure function 223 and EC-EE exposure function 222). Thereafter, the determining steps (309) and (310) maybe performed continuously to update the placement policy dynamically.

The above method steps may be performed by a computing system 401, whose arrangement is shown in FIG. 4. FIG. 4 is a schematic block diagram illustrating a non-limiting example arrangement of the computing system, according to some embodiments herein. The computing system 401 includes the EC-EE monitor 201 coupled to the edge infrastructure 401 and the EC-EE exposure function 222. The computing system 401 also includes energy efficiency management (EEM) function 220 coupled to the service placement function 230 and the EC-EE exposure function 222. The computing system 401 also includes MN-EE monitors 202 and MN-EE exposure function 223 configured to measure energy efficiency of the components of the cellular network. The EEM 220 is configured to receive energy efficiency measurements from the EC-EE monitor 201 and MN-EE monitors 202. The computing system 401 also includes an edge infrastructure 401 which provides computing and other resources like memory or storage being used by the edge services. The system includes a network infrastructure 402 which provides the connectivity between the user devices and the service deployed in the edge infrastructure.

The Edge Cloud Energy Exposure (EC-EE) function 222 is configured to collect the EE metrics which is measured or estimated by the EC-EE Monitors, pre-process the metrics if needed and communicate aforesaid metrics to the Energy Efficiency Management function (EEM) 220. The EEM 220 further communicates the energy efficiency values with the service provision function 230. The service provision function 230 is configured to receive energy efficiency values and identify a set of candidate server groups and further determine an energy efficiency metric for the identified candidate server groups, where the energy efficiency metric helps to define a service placement policy and select a candidate server group for deployment.

According to an embodiment herein, the MN-EE Monitor 202 and MN-EE exposure function 223 could be implemented into existing OAM (Operations, Administration and Maintenance) functions, for example, MN-EE Monitor is part of a Network Manager or an Element Manager, the MN-EE Exposure function 223 is part of the MDAF (Management Data Analytics Function) which can perform related energy efficiency data processing, calculation and determine the information to be exposed towards the edge cloud function or other analytics functions via the Network Exposure Function (NEF) 224.

According to another embodiment herein, the computing system 401 could be implemented as part of 3GPP defined NetWork Data Analytics Function (NWDAF). In an example, MN-EE exposure could be implemented in NWDAF and MN-EE monitoring function can be implemented in every independent 5G network user plane and control plane nodes/elements, such as gNB, User Plane function (UPF), Session Management Function (SMF), Access and Mobility Management Function (AMF). Thereafter, OAM (Operations, Administration and Maintenance) functions can collect the MN-EE metrics from 5G network nodes, then NWDAF can collects MN-EE metrics from OAM and perform data processing, estimation, decision making. Alternatively, NWDAF may directly collect MN-EE metrics from individual 5G nodes/components of the cellular network.

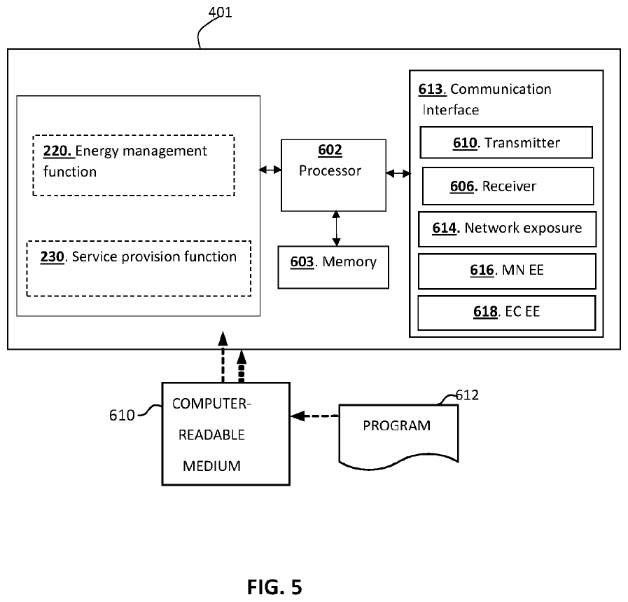

FIG. 5 is a schematic block diagram of the system according to some embodiments herein. As shown in FIG. 5, the system is a computing system 401 that may be part at least one of edge cloud, NWDAF, OAM (Operations, Administration and Maintenance) functions and the like. The computing system 601 may comprise: a processor 602, which may include one or more processors (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed: a communication interface 613 optionally comprising a transmitter (Tx) 610 and a receiver (Rx) 606 for enabling apparatus 600 to transmit data to and receive data from processing circuitry 602 and other nodes or servers.

The computing system 601 further includes a computer readable medium (CRM) 610 for storing a computer program (CP) 612 comprising computer readable instructions (not shown). CRM 610 may be a non-transitory computer readable medium, such as, magnetic media (e.g., a hard disk), optical media, memory devices (e.g., random access memory, flash memory), and the like. In some embodiments, the computer readable instructions of computer program 612 is configured such that when executed by the processor 602, the instructions cause computing system 401 to perform steps described herein (e.g., steps described herein with reference to the flow charts FIG. 3a and FIG. 3b). In other embodiments, computing system 401 may be configured to perform steps described herein without the need for code. That is, for example, the processor 602 may consist merely of one or more ASICs. Hence, the features of the embodiments described herein may be implemented in hardware and/or software.

According to an embodiment herein, the computing system 601, the processor 602 and the receiver 606 is configured to receive a service placement request from a service provider. Thereafter, the processor 602 and the receiver 606 is configured to obtain performance requirements associated with the service placement request from a service provider. The processor 602 along with a service provision function 230 may be configured to identify a set of candidate edge site groups from a plurality of edge sites present in the edge cloud. Herein, the candidate edge sites are adjacent to the user device and satisfy latency and coverage requirements associated with the service placement request. The computing system 601 may comprise an energy management function 220, a network exposure function 614, a Mobile network energy exposure function (MN EE) 616 and an edge cloud exposure function (EC EE) 618. The processor 602 along with EC EE 618 is configured to calculate a first energy efficiency value for each identified candidate edge site group. The processor 602 along with MN EE 616 is further configured to calculate a second energy efficiency value for components of the cellular network that are involved in communication between the user device and the edge site. The processor 602, the Network Exposure Function 614 and the receiver 606 is configured to obtain information comprising the first energy efficiency indicator and the second energy efficiency indicator through the EC EE function 618 and the MN EE function 616. The processor and the service provision function 230 is further configured to determine for each candidate edge site group, an energy efficiency metric for deploying said service placement request in a traffic path of the cellular network based on the first and second energy efficiency values. The processor and the service provision function 230 is further configured to determine a service placement policy for the service placement based on the calculated energy efficiency metric and the obtained performance parameters.

Certain embodiments may provide one or more of the following technical advantages of optimizing overall energy efficiency for the edge services deployed in the mobile edge environment. Further, the service provider, particularly the edge cloud provider can use the information from the energy consumption corresponding to the edge service and then use the information for taking actions to improve the edge service.

When using the word “comprise” or “comprising” it shall be interpreted as non-limiting, i.e., meaning “consist at least of”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### REFERENCES

[1] “Management and orchestration: 5G end to end Key Performance Indicators (KPI)”, TS28.554, 3GPP.
[2] “Management and orchestration: Energy efficiency of 5G”, TS28.310, 3GPP
[3] “Management and orchestration: Study on new aspects of Energy Efficiency (EE) for 5G”, TR28.813, v17.0.0, 3GPP.
[4] “Telecommunication management: Study on system and functional aspects of energy efficiency in 5G networks”, TR32.972, v17.0.0, 3GPP.
[5] Jeong, Yeonwoo, Khan Esrat Maria, and Sungyong Park. “An Energy-Efficient Service Scheduling Algorithm in Federated Edge Cloud.” In 2020 IEEE International Conference on Autonomic Computing and Self-Organizing Systems Companion (ACSOS-C), 48-53, 2020.
[6] Premsankar, Gopika, and Bissan Ghaddar. “Energy-Efficient Service Placement for Latency-Sensitive Applications in Edge Computing.” IEEE Internet of Things Journal, 2022.
[7] “Management and orchestration; 5G end to end Key Performance Indicators (KPI)”, TS28.554, 3GPP.

1. A method performed by a computing system for an energy-efficient service placement in a mobile edge cloud comprising at least one edge site that communicates with a user device through a cellular network, the method comprising:
receiving a service placement request from a service provider;
obtaining performance requirements associated with the service placement request from a service provider;
identifying a set of candidate edge site groups from a plurality of edge sites present in the edge cloud, wherein the candidate edge sites are adjacent to the user device and satisfy latency and coverage requirements associated with the service placement request;
calculating a first energy efficiency value for each identified candidate edge site group;
calculating a second energy efficiency value for components of the cellular network that are involved in communication between the user device and the edge site;
determining, for each candidate edge site group, an energy efficiency metric for deploying said service placement request in a traffic path of the cellular network based on the first and second energy efficiency values; and
determining, a service placement policy for the service placement based on the calculated energy efficiency metric and the obtained performance requirements.

2. The method as claimed in claim 1, wherein determining the service placement policy comprises:
selecting an edge site group for the service placement, from the set of candidate edge site groups, with a highest energy efficiency metric indicator among the determined energy efficiency metrics.

3. The method as claimed in claim 1, further comprising:
requesting for energy efficiency values from the edge cloud and the cellular network;
receiving the cellular network related information comprising latency, network topology and edge infrastructure related information comprising a list of edge sites; and
obtaining information comprising the first energy efficiency value, the second energy efficiency value and performance requirements associated with the application placement request.

4. The method as claimed in claim 1, wherein the performance requirements comprise at least one of latency, throughput, and coverage requirement associated with the service placement request.

5. The method as claimed in claim 1, wherein the determining steps and are performed multiple times over a period of time.

6. The method as claimed in claim 1, comprising updating the service placement policy based on the determined energy efficiency metric.

7. The method as claimed in claim 1, wherein the first energy efficiency value for each of a plurality of candidate edge-site group is calculated by the equation:
$${EE}_{Sc} = \frac{PM}{{EC}_{Sc}}$$
wherein, EE_{Sc} denotes the energy efficiency metric of S_{c}, when service S is deployed in the set of the edge site group c, and PM denotes the performance metrics of S_{c}, and EC_{Sc} is sum of energy consumption related to all replicates of the service S in the edge set c.

8. The method as claimed in claim 1, wherein the second energy efficiency value for components of the cellular network is calculated by the equation:
$${EE}_{{Si}_{ai}} = Avg {\sum }_{m} {EE}_{{tp}_{m}} , m ⊂ BS in area {a}_{i} ,$$
wherein, EE_{Si}_{ₐᵢ} refers to an efficiency related to a data transferred in an area aᵢ, serviceable by the set of candidate edge site groups, and EEₜₚ_{ₘ} denotes an energy efficiency metric along a traffic path from an edge site (i) towards base stations of the cellular network in the serviceable area aᵢ.

9. The method as claimed in claim 1, wherein the components of the cellular network comprise at least one of a base station, a user device, and a user plane function.

10. A computing system for performing energy efficient service placement in a mobile edge cloud, the computing system comprising:
a memory that stores instructions; and
a processor coupled to the memory coupled to the memory to execute the instructions, wherein the instructions cause the computing system to:
receive a service placement request from a service provider;
obtain performance requirements associated with the service placement request from a service provider;
identify a set of candidate edge site groups from a plurality of edge sites present in the edge cloud, wherein the candidate edge sites are adjacent to the user device and satisfy latency and coverage requirements associated with the service placement request;
calculate a first energy efficiency value for each identified candidate edge site group;
calculate a second energy efficiency value for components of the cellular network that are involved in communication between the user device and the edge site;
determine, for each candidate edge site group, an energy efficiency metric for deploying said service placement request in a traffic path of the cellular network based on the first and second energy efficiency values; and
determine a service placement policy for the service placement based on the calculated energy efficiency metric and the obtained performance requirements.

11. (canceled)

12. The computing system as claimed in claim 10, wherein the instructions further cause the computing system to:
select an edge site group for the service placement, from the set of candidate edge site groups, with a highest energy efficiency metric indicator among the determined energy efficiency metrics.

13. The computing system as claimed in claim 10, wherein the instructions further cause the computing system to:
request for energy efficiency values from the edge cloud and the cellular network;
receive the cellular network related information comprising latency, network topology and edge infrastructure related information comprising a list of edge sites; and
obtain information comprising the first energy efficiency value, the second energy efficiency value and performance requirements associated with the application placement request.

14. The computing system as claimed in claim 10, wherein the performance requirements comprise at least one of latency, throughput, and coverage requirement associated with the service placement request.

15. The computing system as claimed in claim 10, wherein the determining steps are performed multiple times over a period of time.

16. The computing system as claimed in claim 10, wherein the instructions further cause the computing system to update the service placement policy based on the determined energy efficiency metric.

17. The computing system as claimed in claim 10, wherein the first energy efficiency value for each of a plurality of candidate edge-site group is calculated by the equation:
$${EE}_{Sc} = \frac{PM}{{EC}_{Sc}}$$
wherein, EE_{Sc} denotes the energy efficiency metric of S_{c}, when service Sis deployed in the set of the edge site group c, and PM denotes the performance metrics of S_{c}, and EC_{Sc} is sum of energy consumption related to all replicates of the service S in the edge set c.

18. The computing system as claimed in claim 10, wherein the second energy efficiency value for components of the cellular network is calculated by the equation:
$${EE}_{{Si}_{ai}} = Avg {\sum }_{m} {EE}_{{tp}_{m}} , m ⊂ BS in area {a}_{i} ,$$
wherein, EE_{Si}_{ₐᵢ}, refers to an efficiency related to a data transferred in an area aᵢ, serviceable by the set of candidate edge site groups, and EEₜₚ_{ₘ} denotes an energy efficiency metric along a traffic path from an edge site (i) towards base stations of the cellular network in the serviceable area aᵢ.

19. The computing system as claimed in claim 10, wherein the components of the cellular network comprise at least one of a base station, a user device, and a user plane function.
